(19) United States
(12) Patent Application Publication
(10) Pub. No.: US 2013/0132156 A1
(43) Pub. Date: May 23, 2013

(54) REAL TIME CUSTOMER SURVEYS

(71) Applicants: David M. GROSSMAN, Brooklyn, NY (US); Engelbert Felberthann, West Orange, NJ (US)

(72) Inventors: David M. GROSSMAN, Brooklyn, NY (US); Engelbert Felberthann, West Orange, NJ (US)

(73) Assignee: MasterCard International Incorporated, Purchase, NY (US)

(21) Appl. No.: 13/301,983

(22) Filed: Nov. 22, 2011

(51) Int. Cl. G06Q 30/02

(52) U.S. Cl. 705/7.32

(57) ABSTRACT

A financial processing system for providing real-time consumer surveys. A financial processing system receives transaction information from a merchant and transmits an authorization request of the transaction to an issuer. The financial processing system transmits approval or denial of the authorization to the merchant. The financial processing system receives an electronic consumer survey from a survey provider based on consumer criteria and transmits the electronic consumer survey to a consumer via a mode of electronic messaging. The financial processing system can include a database to store consumer criteria, consumer account numbers, and consumer general and merchant-specific shopping and response characteristics.

### FIELD OF THE INVENTION

The present disclosure relates to a system and method in which a financial transaction processing system provides electronic consumer surveys from a survey provider to a consumer following a financial transaction.

### BACKGROUND OF THE INVENTION

Financial transaction processing systems operate to facilitate transactions between at least a consumer, an issuer, and a merchant. When a consumer engages in a financial transaction with a merchant, such as by using a credit card, the financial transaction system sends an authorization request to an issuer, such as the consumer's bank. Upon receiving authorization or denial from the issuer, the financial transaction processing system notifies the merchant accordingly and the financial transaction is completed.

Survey providers create consumer surveys for consumers to complete for any variety of reasons, such as to obtain marketing information, analyze shopping habits, to assist with advertising, or to test new products in the market. Those who benefit from these consumer surveys include the survey providers, research and marketing firms, merchants, and even the consumers themselves. Providing consumers with a survey at a relevant and opportunistic time is a goal of survey providers.

Some effort has been made to capture real-time, point of sale (POS)-oriented consumer surveys that are specifically tied to the merchant's POS capabilities. However, known systems do not leverage payment account information to trigger a consumer survey. Moreover, known consumer surveys are either physical mail deliveries or Internet based upon accessing specific web pages on the World Wide Web. Generally, the customization or targeting of these surveys are limited to information about the customer while coming to, exploring, and leaving a given website. ComScore has a panel of people who permit tracking of their web experience, but this is generally limited to the people who have opted into the panel for some form of consideration. See, e.g., U.S. Pat. No. 7,181,412.

Thus, a need exists for delivery of consumer surveys that are triggered by a financial transaction and that pertain to a consumer's specific shopping experience based upon a variety of predetermined characteristics.

### SUMMARY OF THE INVENTION

Systems and methods for providing real-time electronic consumer surveys are disclosed herein.

It is noted initially that, as used herein, the term “financial card” can include, for example, magnetic stripe bearing card, smart card, magnetic stripe and smart card combination, prepaid card, credit card, debit card, combination credit/debit card, Visa(R), MasterCard®, American Express®, Diners Club, Discover® Card, merchant card, or any other card suitable for a cardholder to use to make purchases of goods and/or services. Also, as used herein, the terms “cardholder,” “card user,” and “card recipient” can be used interchangeably and can include any user making purchases of goods and/or services. Further, as used herein in, the term “issuer” or can include, for example, a financial institution (i.e., bank) issuing a card, a merchant issuing a merchant specific card, a stand-in processor configured to act on-behalf of the card-issuer, or any other suitable institution configured to issue a financial card.

Exemplary embodiments of the present disclosure provide an advantageous feature by which a financial transaction processing system provides consumers with electronic consumer surveys through a mode of electronic messaging upon completion of a financial transaction with a merchant. A survey provider transmits to the financial transaction processing system an electronic consumer survey, which is then transmitted to the consumer from the financial transaction processing system upon a triggering event, such as upon obtaining transaction authorization from an issuer.

According to an exemplary embodiment, the present disclosure provides a system and method by which a financial transaction processing system provides an electronic consumer survey to a consumer. When a consumer/cardholder engages in a financial transaction with a merchant that is a party to the financial transaction processing system, such as by using a credit card (e.g., MasterCard®), the financial transaction processing system transmits an authorization request to an issuer, such as the financial institution (e.g., bank) that issued the consumer's credit card. Upon receiving an authorization or denial of the financial transaction from the issuer, the financial transaction processing system notifies the merchant of the authorization or denial and also transmits an electronic consumer survey to the consumer via a mode of electronic messaging after completion of the financial transaction. Of course, it is possible that the survey be sent upon receipt of an authorization request.

The electronic consumer survey can be provided to the consumer at various times upon completion of the financial transaction. In some embodiments, the electronic consumer survey can be transmitted immediately following the transaction (whether merely initiated or completed). In other embodiments, the consumer survey can be transmitted based upon time-distribution desires or requirements predetermined by the survey provider. In yet other embodiments, the electronic consumer survey can be transmitted after a time delay, such as after a numbered minutes, hours, or days subsequent to the completion of the financial transaction. While the distribution timing of electronic survey is not limited to any one time, it can be based upon a time predetermined by a survey provider or set by default.

The distribution of electronic consumer surveys is also based upon a plurality of predetermined factors. For example, the electronic consumer surveys can be provided to a consumer based upon the merchant from which the financial transaction is occurring, but may also use additional criteria such as demographic information of the consumer (non-personally identifiable information (PII) received from, e.g., a credit bureau), geographical location of the transaction, time and date of the transaction, monetary amount of the transaction, specific department within the merchant, or any other suitable predetermined criteria.

The electronic consumer survey can be transmitted to the consumer via any mode of electronic messaging. For example, the electronic consumer survey can be transmitted as a short message service (SMS) (i.e., a text message) to the cellular device (i.e., cellular phone) of the consumer or as an electronic mail (e-mail) to the consumer, or it can be transmitted to a nearby kiosk or terminal, such as one at the location of the merchant where the financial transaction occurs or a consumer's computer. The electronic consumer survey can also be transmitted through an application on a Smartphone, for example.

These and other features of the present disclosure will be readily appreciated by one of ordinary skill in the art from the following detailed description of various implementations when taken in connection with the accompanying drawings.

### BRIEF DESCRIPTION OF THE DRAWING FIGURES

FIG. 1 is a block diagram illustrating a financial processing system according to an embodiment of the disclosed system.

FIG. 2 is a block diagram illustrating bi-directional communication of the financial processing system of FIG. 1 with a plurality of parties external to the system according to an embodiment of the disclosed system.

FIGS. 3 and 4 are simplified block diagrams illustrating bi-directional communication of the financial processing system of FIGS. 1 and 2 for distributing consumer surveys.

FIG. 5 is a flowchart illustrating a method for distributing real-time electronic consumer surveys to consumers via the financial processing system of FIG. 1 according to an embodiment.

FIGS. 6 and 7 are flowcharts illustrating additional methods for distributing consumer surveys via the financial processing system of FIG. 1 according to an embodiment.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION OF THE INVENTION

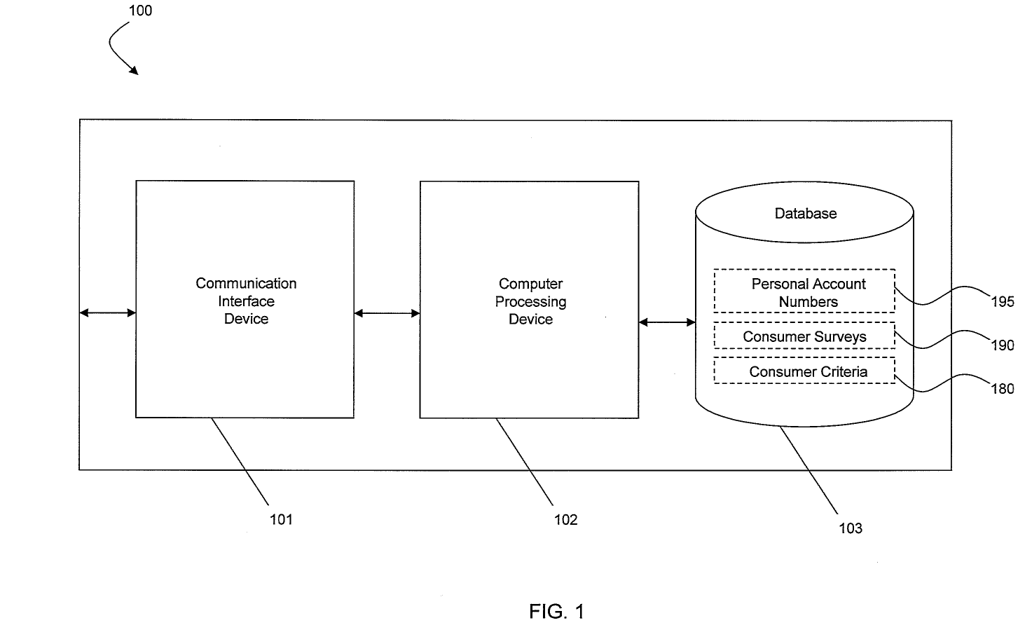

FIG. 1 is a block diagram illustrating a financial processing system 100 according to an embodiment of the disclosed system. The financial processing system 100 includes a communication interface device 101, a computer processing device 102, and a database 103.

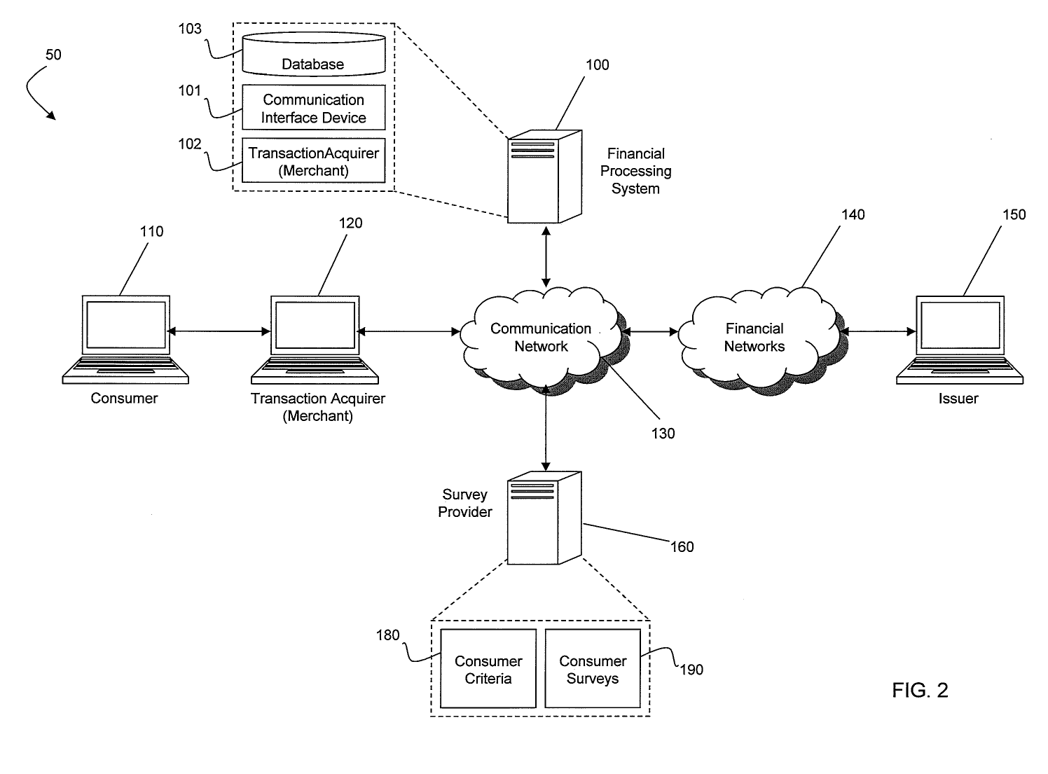

The financial processing system 100 is implemented in a financial system 50 for providing real-time consumer surveys to a consumer 110 (illustrated in e.g., FIGS. 2-4). The financial system 50 can be implemented in a communication network 130. The communication network 130 can be any suitable communication network configured to support electronic financial transactions (e.g., debit, credit, automatic teller machine (ATM) transactions, etc.). Suitable communication networks include, but are not limited to, a wide area network (WAN), local area network (LAN), the Internet, wireless network, landline, cable line, fiber-optic line, etc.

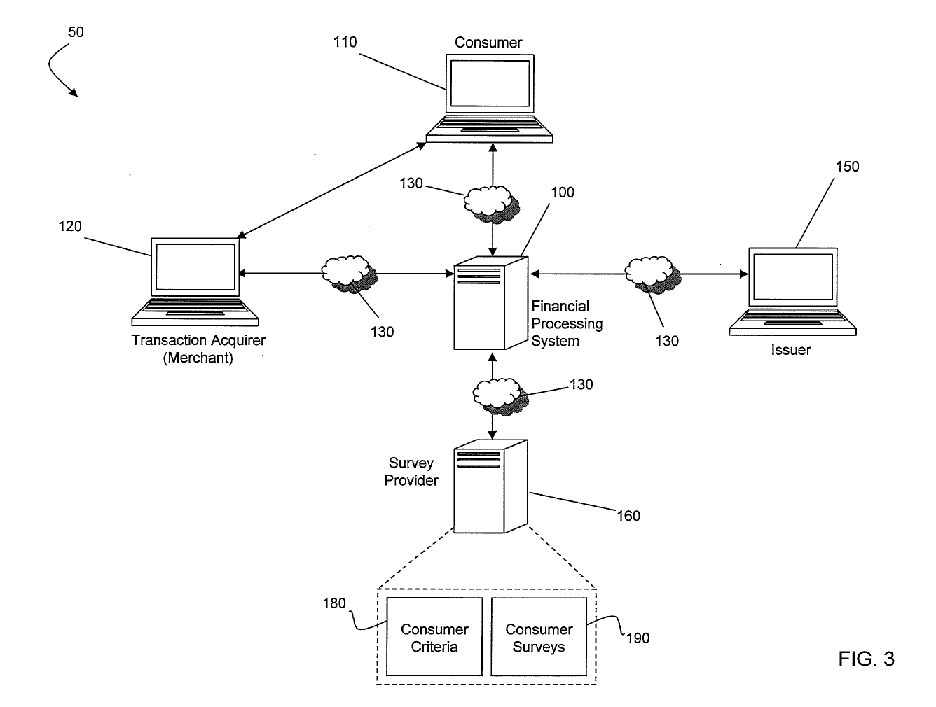

The communication interface device 101 of the financial processing system 100 provides one or more communication paths from the financial processing system to and from other systems. For example, the communication interface device 101 can provide a communication path to or from a communication network 130 (illustrated in FIG. 2) or to or from a merchant 120 (illustrated in FIG. 3). Types of communication paths utilized by the communication interface device 101 will be apparent to persons having skill in the relevant art(s). The communication interface device 101 is configured to send and receive transaction authorizations, to send and receive approval or denial notifications, to send and receive electronic consumer surveys to and from a survey provider 160 or to or from a consumer 110, and to send and receive transaction information.

The computer processing device 102 of the financial processing system 100 is configured to receive transaction information from the merchant 120, electronic consumer surveys from the survey provider 160, and specified consumer criteria (also from the survey provider 160), via the communication interface device 101 and to further communicate with the database 103 (discussed in more detail below). The computer processing device 102 is also configured to compare consumer transaction information received from the merchant 120 with consumer criteria and to select a respective electronic consumer survey for distribution to the consumer 110. The computer processing device 102 can be any type of processing device that is suitable for performing the functions discussed herein, such as a central processing unit (CPU), a personal computer, an array of a plurality of CPUs or personal computers, or any other processing device. The computer processing device 102 can operate via implementations of hardware, of software, or of a combination of both hardware and software. The types of computer processing devices and methods for carrying out the processing will be apparent to persons having skill in the relevant art(s).

The database 103 of the financial processing system 100 is configured to store a variety of information pertaining to the financial processing system 50. For example, the database 103 is configured to store predetermined consumer criteria 180 received from the survey provider 160 and store electronic consumer surveys 190 (also received from the survey provider 160). The database 103 is further configured to store personal account numbers 195 (associated with financial cards) of consumers, as well as general and merchant-specific spending and response characteristics of consumers linked to their personal account numbers. Additionally, the database 103 is configured to store consumer profiles, including information provided by the consumers. The database 103, while illustrated in FIG. 1 as being external to the computer processing device 102, can, in alternative embodiments, be implemented within the computer processing device 102. The type of database used may include a relational database management system (RDBMS). Methods of storing and accessing the information in the database will be apparent to persons having skill in the relevant art(s). For example, a query language such as Standardized Query Language (SQL) or QUEL can be used.

The consumer profiles stored within the database 103 include specific information provided by individual consumers. Such information can include, e.g., name, contact information, preferred modes of electronic communication for distribution of electronic surveys. In other words, a consumer can provide the system with detailed information that can assist in the system's distribution of real-time electronic consumer surveys.

FIG. 2 illustrates a more detailed overview of the financial processing system 100 of FIG.1 within the financial transaction system 50 including bi-directional communication of the system 100 of FIG. 1 with parties external to the system 100 for providing real-time consumer surveys. As illustrated in FIG. 2, the financial transaction system 50 includes at least a consumer 110, a transaction acquirer (merchant) 120, an issuer 150, and the financial processing system 100 of FIG. 1. The consumer 110 engages in a financial transaction with the transaction acquirer (merchant) 120. Such financial transactions can be, for example, point-of-sale (POS) transactions, or transactions that are performed electronically, such as through the Internet. Types of consumer-merchant transactions that can be used in the financial transaction system 50, as well as the information exchanged between the consumer 110 and merchant 120, will be apparent to persons skilled in the relevant art(s).

The financial processing system 100 communicates with the merchant 120 and the issuer 150 via communication network 130. Specifically, the financial processing system 100 receives specific transaction information pertaining a financial transaction between the merchant 120 and consumer 110, which is transmitted through the communication network 130 upon initiation of the financial transaction. The financial processing system 100 processes the transaction by forwarding the transaction information through a particular financial network 140 and transmitting an authorization request to the issuer 150. The issuer can be, for example, a bank that had issued the credit card that the consumer 110 used in the financial transaction. The issuer 150 will then return either an authorization or denial of the financial transaction to the financial processing system 100 via the communication network 130. Once the financial processing system 100 receives authorization of the financial transaction from issuer 150, and if the transaction information meets predetermined criteria (described in more detain herein), the financial processing system 100 is configured to transmit an electronic consumer survey 190 (received from survey provider 160) via the communication network 130 to the consumer. The electronic consumer surveys, in some embodiments, can be received from a survey provider 160 and stored within the database 103 of the financial processing system 100 prior to any financial transactions. Thus, further communication between the survey provider 160 and financial processing system 100 could be limited. In other embodiments, the electronic surveys would not be released from the survey provider 160 until a financial transaction occurs thereby triggering communication between the financial processing system 100 and survey provider 160.

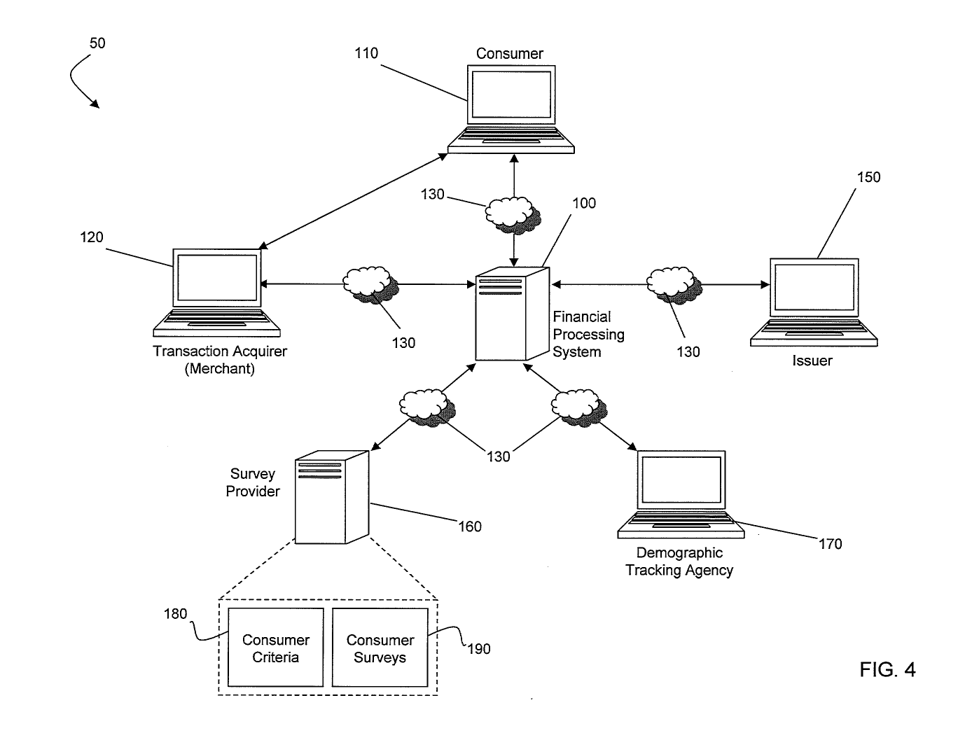

The survey provider 160 can be, for example, a research or marketing firm, a consumer products company, the merchant 120 itself, or any other entity wishing to receive feedback from consumers. Moreover, while the survey provider 160 is illustrated as being external to the financial processing system 100, in some embodiments, the survey provider 160 can be implemented within the financial processing system 100. The electronic consumer survey provided by the survey provider 160 can be based upon the merchant 120 as well as additional survey criteria 180 predetermined by the survey provider, and stored within the database 103 of the financial processing system 100. The criteria 180 can include, for example, geographical information of the merchant 120, the amount of the financial transaction, date and time information of the transaction, and/or demographic information of the consumer received by a demographic tracking agency 170 (e.g., a credit bureau), shown e.g., in FIG. 4.

Upon receiving authorization of the financial transaction from the issuer 150, the financial processing system 100 finalizes the transaction and transmits the electronic consumer survey to the consumer 110 via the mode of electronic messaging specified by the consumer in the consumer profile stored in the database 103 of the financial processing system 100. Along with the electronic consumer survey, the financial processing system 100 also transmits an incentive/reward that is guaranteed to the consumer 110 if the consumer 110 completes the survey. The mode of electronic messaging can be, for example, an SMS text message or an e-mail message. The consumer 110 can also specify/request that the survey to be transmitted to a kiosk or terminal available to the consumer 110, or to a smart card application such as one on a consumer's Smartphone or tablet. Additional modes of electronic messaging will be apparent to persons skilled in the relevant art(s). The financial processing system 100 transmits the survey to the consumer 110 within a time period, upon completion of the financial transaction, predetermined by the survey provider 160. The predetermined time for transmission upon completion of the financial transaction can be, for example, immediately following the transaction or after a significant time period such as one hour or several days. In some embodiments, the financial processing system 100 receives distribution time-frame requirements from the survey provider 160 and stores the requirements within the database 103.

FIGS. 3 and 4 further illustrate the bi-directional communication between financial processing system 100 and parties external to the system 100 of FIGS. 1 and 2. The communication network 130 and financial networks 140 are not depicted in FIGS. 3 and 4 merely for simplification purposes. It should be understood, however, that the financial transaction system 50 is implemented within a communication network and utilizes financial networks allowing communication between the parties illustrated in FIGS. 3 and 4. As illustrated, the financial processing system 100 is configured to communicate with at least the consumer 110, merchant 120, issuer 150, and survey provider 160 within the financial transaction system 50. In some embodiments, as illustrated in FIG. 4, the financial processing system 100 can further communicate with a demographic tracking agency 170 in order to receive demographic information pertaining to the consumer 110 of a specific financial transaction. Demographic information can include non-personally identifiable information (PII), including (depending on how PII is defined), for example, the age, income, education, or gender of the consumer. Other types of demographic information will be apparent to persons skilled in the relevant art(s).

The demographic information regarding the consumer 110 provided to the financial processing system 100 by the demographic tracking agency 170 can be used in conjunction with specific consumer criteria provided by the survey provider 160, and with the consumer's transaction information in order to determine if the consumer 110 is eligible for receiving a survey. For example, the survey provider 160 can provide a list of multiple electronic consumer surveys to the financial processing system 100 in addition to criteria that a consumer must meet to receive a survey. Criteria can include, for example, (1) a specific range of a monetary amount of a financial transaction, (2) that the transaction occurred during a certain time frame, (3) that the consumer is of a certain gender, and (4) is of a certain age. The financial processing system 100 can then search the database 103, upon the triggering of a financial transaction, for demographic information pertaining to the consumer 110 received from the tracking agency 170, and compare the demographic information and transaction information with the predetermined criteria to determine which electronic consumer survey should be transmitted to the consumer 110.

As a specific example, the financial processing system 100 can receive predetermined criteria indicating that a survey is to be provided to e.g., female consumers in the age bracket of 25-34 years who spend in excess of $100.00 during the months of June, July, and August at retailers such as Wal-Mart, Target, etc. Upon the triggering of a financial transaction, the processing system 100 compares the transaction information (e.g., merchant, transaction amount, etc.), along with demographic information pertaining to the consumer 110 received from the tracking agency 170 to determine if the consumer 110 and transaction meet the specific criteria. If the consumer transaction and any consumer demographic information meets the required criteria predetermined by the survey provider 160, a survey is distributed via the mode of electronic messaging provided by the consumer 110 along with an incentive for the consumer's potential completion of the survey. Incentives can include, e.g., discounts, coupons, merchant-funded offers, or other special offers. For example, the financial processing system 100 would transmit a survey to the consumer if the consumer is, e.g., a female of age 27 (as determined by demographic information) who spent $190.00 at Target in the month of July, the financial processing system 100 would transmit a survey to the consumer. The financial processing system 100 would not, however, transmit a survey to a consumer if the consumer and/or transaction information did not meet the specified criteria. For example, if the consumer 110 is male (as determined by demographic information), then a survey would not be distributed as the consumer and/or transaction information did not meet the female requirement specified by the survey provider 160. If the consumer is female, for example, with an age within the specified age bracket, but only spent e.g., $50.00, for example, a survey would not be distributed since the consumer and/or transaction information did not meet the spending requirement specified by the survey provider 160 in this example.

Thus, the distribution of surveys is consumer specific, based upon the consumer's specific shopping characteristics and/or habits, and based upon specific criteria predetermined by the survey provider 160.

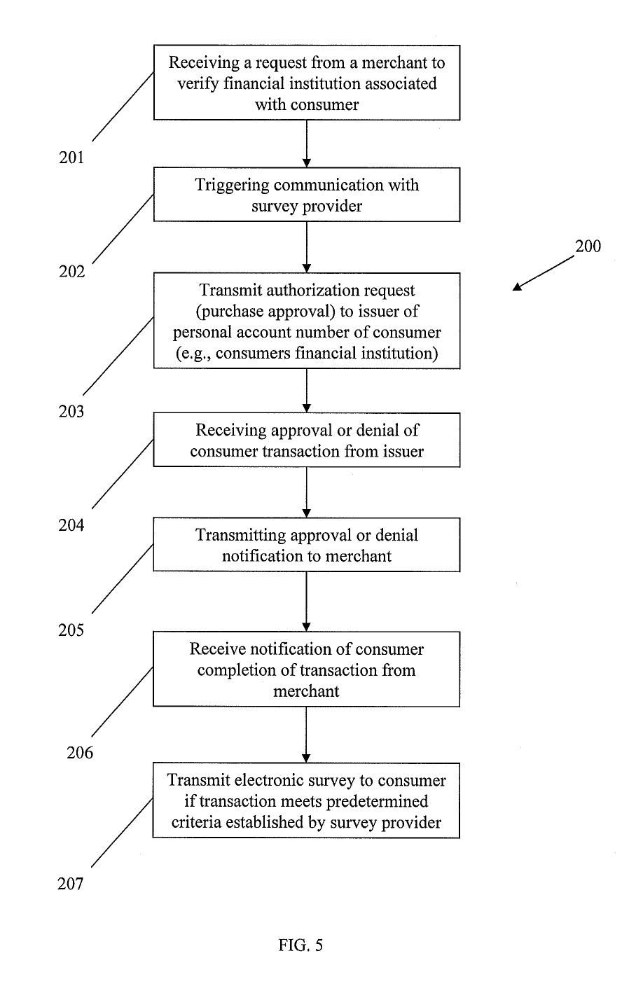

FIGS. 5-7 illustrate flow charts 200, 300, and 400 demonstrating a method for providing real-time electronic consumer surveys via the financial processing system 100 of FIG. 1.

At step 201 of FIG. 5, a financial processing system (illustrated in FIG. 1) receives a request from a merchant, upon the initiation of a financial transaction by a consumer, to verify a financial institution associated with the consumer. The financial institution can be, for example, a bank that issued the consumer a credit card that was used for the financial transaction.

At step 202, the financial processing system triggers communication with a survey provider for receiving specific consumer criteria for the consumer or transaction to meet and surveys. The survey provider can be, for example, a marketing or research firm, a consumer products manufacturer, the financial processing system, or the merchant taking part in the financial transaction.

At step 203, the financial processing system transmits transaction information along with an authorization request to the issuer of the personal account number (associated with a financial card) of the consumer seeking approval of the transaction made by the consumer at the merchant. The issuer can be, for example, the consumer's financial institution, such as the bank or a company that issued a credit card the consumer used in the financial transaction.

At step 204, the financial processing system receives approval or denial of the consumer transaction from the issuer. The nature of the notification of approval or denial of the transaction will be apparent to persons skilled in the relevant art(s). At step 205, the financial processing system transmits the approval or denial as a notification to the merchant, and at step 206, the financial processing system receives notification from the merchant that the financial transaction with the consumer has been completed.

The financial processing system, at step 207, transmits an electronic consumer survey to the consumer if the financial transaction meets predetermined criteria established by the survey provider, either when the authorization request is received, or after the authorization/denial message is generated. Predetermined criteria can be, for example, the monetary amount of the transaction, geographic location, the time and date of the transaction, etc. The transmission of the survey can be performed using various electronic methods that would be apparent to persons skilled in the relevant art(s), such as SMS text messaging or e-mail.

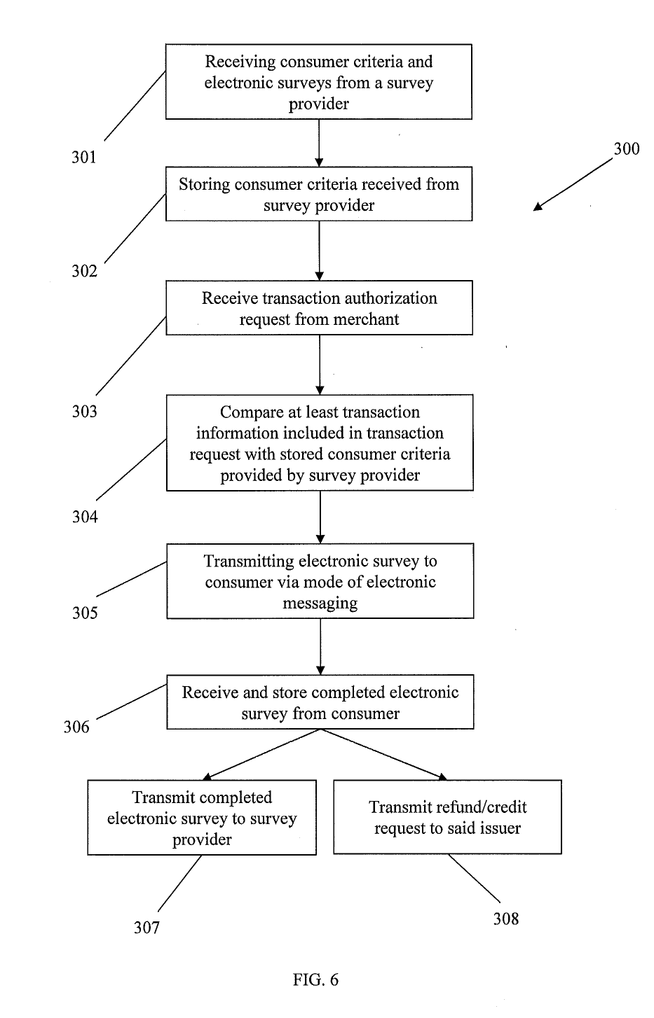

At step 301 of FIG. 6, a financial processing system (illustrated in FIG. 1) first communicates with the survey provider and receives consumer criteria and electronic surveys, and at step 302, stores the consumer criteria and surveys received from the survey provider. The different types of electronic surveys will be apparent to persons skilled in the relevant art(s). The consumer criteria can include a type of the financial transaction, an amount of a financial transaction, a time or date of a financial transaction, or any other suitable consumer criteria.

At step 303, the financial processing system receives a transaction authorization request from a merchant triggering a comparison of information (discussed in more detail herein). The transaction can be, for example, a POS transaction or an electronic transaction such as one over the Internet. Upon receiving the transaction request, the financial processing system, at step 304, compares at least the transaction information included in the transaction request of step 303 with the consumer criteria received by the survey provider at step 301 and stored at step 302. In addition to the consumer criteria, the financial processing system can also compare the transaction information with other information, such as demographic information obtained from a demographic tracking agency that includes, for example, the gender, age, income, or education of the consumer. Other types of information that would be beneficial to compare will be apparent to persons skilled in the relevant art(s). Comparing the transaction information with at least the stored consumer criteria can result in the financial processing system determining if a survey should be distributed or identifying a particular survey from a plurality of different surveys.

Upon determining that a consumer is eligible to receive a survey, the financial processing system, at step 306, transmits the electronic consumer survey to the consumer of the financial transaction via a consumer specified mode of electronic messaging. The mode of electronic messaging can transmit the electronic consumer survey, for example, by SMS text message or electronic mail, or to a kiosk or terminal accessible by the consumer. The electronic consumer survey can also be transmitted to the consumer through a smart card application, such as existing on a Smartphone or a tablet. The electronic consumer survey can also be transmitted to the consumer at any time upon completion of the survey that is specified by the survey provider. In some embodiments, as illustrated in FIG. 6, the financial processing system also transmits, along with the survey, an incentive/reward that is consumer guaranteed in return for completion of the survey. Incentives/rewards can include e.g., a refund, credit request, or other incentive to the issuer of the financial transaction or can include discounts, coupons, merchant-funded offers, or other special offers, for example. In some embodiments, the survey provider can include a time period for consumer completion of the survey. In such embodiments, if the consumer survey has not been completed, the reward/incentive can then be voided. In other embodiments, the survey provider can indicate a threshold value pertaining to unanswered surveys for any given consumer. In such embodiments, if a consumer receives a certain number of surveys, doesn't complete the surveys and reaches the unanswered threshold value indicated by the survey provider, the consumer would no longer receive electronic surveys.

Once the consumer completes the electronic survey, the financial processing system, at step 306, receives the complete electronic survey from the consumer and stores the completed survey in the database. In some embodiments, the financial processing system processes the spending and response characteristics of the consumer and stores it in a database linked with the personal account number of the consumer. Upon receipt and storage of the completed survey, the financial processing system, at step 307, transmits the completed and stored electronic consumer survey to the survey provider, and at step 308 transmits the guaranteed incentive to the consumer. Incentives can include e.g., a refund, credit request, or other incentive to be sent to the issuer of the financial transaction, or discounts, coupons, merchant-funded offers, or other special offers. In the case of certain incentives, it may be more efficient to transmit the incentive directly to the consumer instead of the issuer.

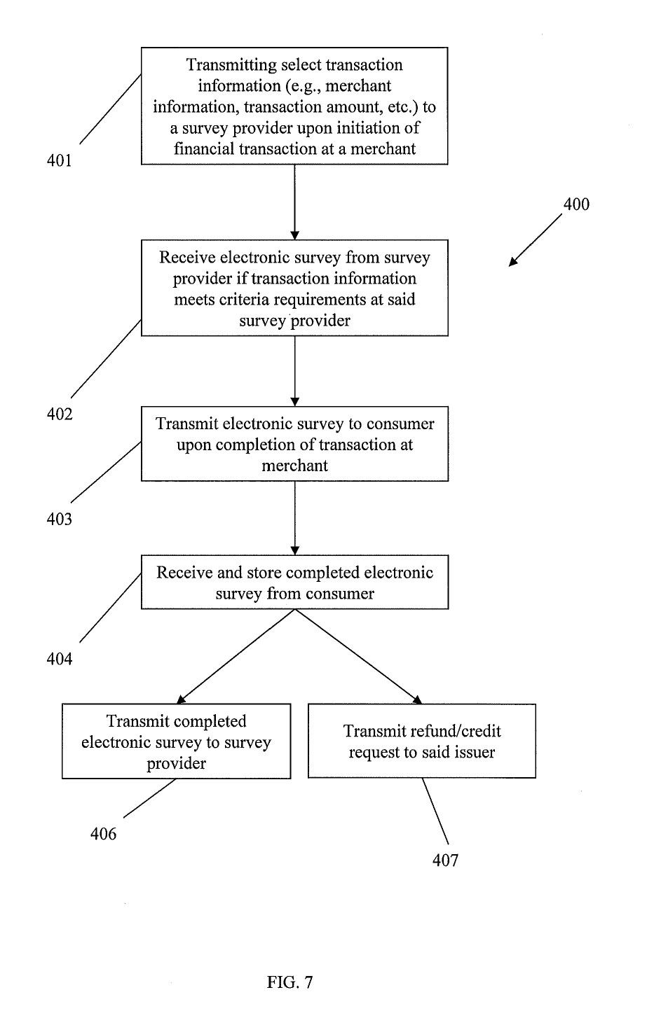

The method depicted by the flowchart 400 of FIG. 7 differs from that of FIG. 6 in that it does not first receive surveys and consumer criteria from the survey provider, but rather transmits pertinent information to the survey provider upon the triggering of a financial transaction between a consumer and a merchant prior to receiving surveys and consumer criteria fro the survey provider. At step 401 of FIG. 7, the financial processing system (illustrated in FIG. 1) transmits transaction information to a survey provider upon initiation of a financial transaction by a consumer at a merchant. The transaction information can include, for example, the name or type of merchant and/or the amount of the transaction, or other specific information requested by the survey provider.

At step 402, if the transaction information meets specific criteria requirements predetermined by the survey provider, the financial processing system will receive an electronic consumer survey from the survey provider. Alternatively, the survey provider can provide different surveys based on the transaction information and specific criteria requirements. The types and nature of the criteria requirements will be apparent to persons having skill in the relevant art(s). Upon completion of the transaction and upon receiving the electronic survey from the survey provider, the financial processing system transmits the electronic consumer survey to the consumer by way of a consumer specified/preferred mode of electronic messaging, along with an incentive/reward that is consumer guaranteed in return for survey completion. The electronic consumer survey can be transmitted, for example, by SMS text message or electronic mail, or to a kiosk or terminal accessible by the consumer. The electronic consumer survey can also be transmitted to the consumer through an application, such as existing on a Smartphone or a tablet. The electronic consumer survey can also be transmitted to the consumer at any time upon completion of the survey that is specified by the survey provider.

Upon consumer completion of the electronic survey, at step 404, the financial processing system receives the consumer completed electronic survey and stores it in the database of the system (as shown in FIG. 1). In some embodiments, the financial processing system processes the spending and response characteristics of the consumer and stores it in a database linked with a personal account number of the consumer. Upon receipt and storage of the completed survey, the financial processing system, at step 405, transmits the completed and stored electronic consumer survey to the survey provider, and, at step 406, transmits the guaranteed incentive/reward to the consumer. Incentives/rewards can include e.g., a refund, credit request, or other incentive to the issuer of the financial transaction or can include discounts, coupons, merchant-funded offers, or other special offers, for example. In the case of certain incentives, it may be more efficient to transmit the incentive directly to the consumer instead of the issuer. It will be apparent to persons skilled in the relevant art(s) that step 76 is an optional step.

Where methods described above indicate certain events occurring in certain orders, the ordering of certain events may be modified. Moreover, while a process depicted as a flowchart, block diagram, etc., may describe the operations of the system in a sequential manner, it should be understood that many of the system's operations can occur concurrently. For example, although the financial processing system 100 is disclosed and illustrated (e.g., in FIG. 6) as being configured to receive and store consumer criteria from a survey provider prior to receiving a transaction authorization request from a merchant, in some embodiments, the system 100 can first receive the transaction authorization request from the merchant prior to receiving consumer criteria from the survey provider. In other embodiments, the system can concurrently receive both the consumer criteria and the transaction authorization request.

Techniques consistent with the present disclosure provide, among other features, a system and method of providing real-time consumer surveys. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope. The scope of the invention is defined by the claims and their equivalents.

What is claimed is:

1. A method for providing real-time consumer surveys, comprising:
receiving, by a processor, an authorization request including financial transaction information pertaining to an electronic financial transaction conducted by a consumer at a merchant;
transmitting said authorization request to an issuer for authorization of said transaction;
receiving, from said issuer, authorization or denial of said financial transaction;
receiving an electronic consumer survey, from a survey provider, said survey being based upon survey criteria predetermined by the survey provider;
transmitting said electronic consumer survey to said consumer via a mode of electronic messaging within a predetermined time from said time of financial transaction completion at said merchant.

2. The method of claim 1, wherein said electronic survey is transmitted to said consumer upon authorization and completion of said financial transaction at said merchant.

3. The method of claim 1, further comprising:
comparing said financial transaction information received from said merchant with said predetermined survey criteria provided by said survey provider to determine if said consumer meets criteria for receiving a survey.

4. The method of claim 1, wherein said electronic consumer survey is transmitted to said consumer when said financial transaction information meets said predetermined survey criteria provided by said survey provider.

5. The method of claim 1, further comprising:
transmitting a completed electronic consumer survey from said consumer to said survey provider.

6. The method of claim 1, wherein said electronic consumer survey includes a consumer incentive for completion.

7. The method of claim 6, wherein said consumer incentive includes at least one of an electronic financial refund, a discount, a merchant-funded offer, or a credit to said consumer's personal account.

8. The method of claim 1, further comprising:
transmitting an electronic financial refund or funding request to said issuer upon completion of said electronic consumer survey by said consumer.

9. The method of claim 1, wherein said mode of electronic messaging includes at least one of a smart card application, short message service (SMS) message, electronic mail (e-mail), kiosk, or terminal.

10. The method of claim 1, further comprising:
storing, in a database, personal account numbers of consumers.

11. The method of claim 10, further comprising:
linking, in said database, shopping characteristics of said consumers with respect to merchants to said personal account numbers.

12. The method of claim 10, further comprising:
linking, in said database, general and merchant-specific spending characteristics of said consumers to said personal account numbers.

13. The method of claim 10, further comprising:
linking, in said database, response characteristics of said consumers with respect to a plurality of completed electronic consumer surveys to said personal account numbers.

14. A method for providing real-time consumer surveys comprising:
receiving, by a computer processor, predetermined consumer criteria from a survey provider for the distribution of electronic consumer surveys;
storing, in a database, personal account numbers of consumers and shopping characteristics associated with said personal account numbers with respect to merchants;
comparing said predetermined consumer criteria received from said survey provider with said shopping characteristics of said consumer upon a transaction authorization request from a specific merchant; and
transmitting said electronic consumer survey to a consumer via a mode of electronic messaging upon authorization of said transaction authorization request and completion of a consumer transaction.

15. The method of claim 14, further comprising:
receiving distribution time-frame requirements from said survey provider including a predetermined time for which said electronic consumer survey is to be transmitted to said consumer upon said transaction authorization and completion.

16. The method of claim 14, further comprising:
storing, in said database, completed electronic consumer surveys, associated with said personal account numbers of consumers.

17. The method of claim 14, wherein said electronic consumer survey includes a consumer incentive for completion.

18. The method of claim 17, wherein said consumer incentive includes at least one of an electronic financial refund, a discount, a merchant-funded offer, or a credit to said consumer's personal account.

19. The method of claim 14, further comprising:
transmitting an electronic financial refund or funding request to said issuer upon completion of said electronic consumer survey by said consumer.

20. The method of claim 14, wherein said mode of electronic messaging includes at least one of a smart card application, short message service (SMS) message, electronic mail (e-mail), kiosk, or terminal.

21. The method of claim 14, further comprising:
linking, in said database, general and merchant-specific spending characteristics of said consumers to said personal account numbers.

22. The method of claim 14, further comprising:
linking, in said database, response characteristics of said consumers with respect to a plurality of completed electronic consumer surveys to said personal account numbers.

23. A financial transaction processing system for providing real-time consumer surveys, comprising:
a communication interface device configured to communicate with a communications network;
a database for storing personal account numbers of consumers and preferred modes of electronic messaging of said consumers, wherein said database links personal account information with merchant specific spending characteristics of said consumers;
a computer processing device configured to receive consumer survey criteria information from a survey provider for the distribution of electronic consumer surveys to consumers and to transmit a consumer survey to a consumer via the preferred mode of electronic messaging of said consumer upon completion of a financial transaction, wherein said survey is based upon consumer criteria provided by said survey provider.

24. The financial transaction processing system of claim 23, wherein said computer processing device compares said survey criteria provided by said survey provider with at least one of financial transaction information associated with a financial transaction authorization request, received from said merchant, or said spending characteristics of said consumer stored in said database.

25. The financial transaction processing system of claim 23, wherein said database links said personal account numbers of said consumers with consumer surveys completed by said consumers.

26. The financial transaction processing system of claim 23, wherein said database links said personal account numbers of said consumers with response characteristics of said consumers with regard to electronic consumer surveys previously completed by said consumers.

27. The financial transaction processing system of claim 23, wherein said communications interface device transmits said electronic consumer survey to said consumer when said financial transaction information meets said survey criteria provided by said survey provider.

28. The financial transaction processing system of claim 23, wherein said communications interface device transmits said electronic consumer survey to said consumer when said spending characteristics of said consumer meet said survey criteria provided by said survey provider.

29. The financial transaction processing system of claim 23, wherein said communications interface device transmits a completed electronic consumer survey to said survey provider.

30. The financial transaction processing system of claim 23, wherein said electronic consumer survey includes a consumer incentive for completion.

31. The financial transaction processing system of claim 30, wherein said consumer incentive includes at least one of an electronic financial refund, a discount, a merchant-funded offer, or a credit to said consumer's personal account.

32. The financial transaction processing system of claim 23, wherein said communications interface device transmits an electronic financial refund or funding request to said issuer upon completion of said electronic consumer survey by said consumer.

33. The financial transaction processing system of claim 23, wherein said preferred mode of electronic messaging includes at least one of a smart card application, short message service (SMS) message, electronic mail (e-mail), kiosk, or terminal.
